(19) United States
(12) Patent Application Publication
(10) Pub. No.: US 2008/0047543 A1
(43) Pub. Date: Feb. 28, 2008

(54) GAS-POWERED TOOL

(76) Inventor: Arlo Lin, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/466,293

(22) Filed: Aug. 22, 2006

(51) Int. Cl. B44D 3/16; B65D 5/66

(52) U.S. Cl. 126/401; 222/113

(57) ABSTRACT

There is disclosed a gas-powered tool. The gas-powered tool includes a barrel, a combustor and a controller. The combustor is installed in the barrel to combust gas. The controller is installed in the barrel to control the temperature by controlling the supply of the gas to the combustor. The overheating of the gas-powered tool is prevented.

### BACKGROUND OF INVENTION

1. Field of Invention

The present invention relates to a gas-powered tool and, more particularly, to a controller for controlling the supply of gas in such a gas-powered tool.

2. Related Prior Art

There are two types of apparatuses for providing thermoplastic glue. The first type is energized by electricity. The second type is energized by gas.

An electrical gluing apparatus includes an electrical heater to provide heat so that thermoplastic glue can be heated, molten and provided on things to be attached to one another. However, it takes quite some time for the electrical heater to provide enough heat to the thermoplastic glue before thermoplastic glue is molten. To save such time in waiting, the electrical gluing apparatus is actuated all the time. However, this causes the continuous heating and melting of the thermoplastic glue that inevitably drips.

A gas-powered gluing apparatus includes a combustor for burning gas to provide heat. Compared with the electrical gluing apparatus, the gas-powered gluing apparatus warms up fast. Hence, the gas-powered gluing apparatus is preferred to the electric gluing apparatus. However, with the supply of gas continued, the gas-powered gluing apparatus might overheat and cause damage thereto and/or injury to a user.

The present invention is therefore intended to obviate or at least alleviate the problems encountered in prior art.

### SUMMARY OF INVENTION

A gas-powered tool includes a barrel, a combustor and a controller. The combustor is installed in the barrel to combust gas. The controller is installed in the barrel to control the temperature by controlling the supply of the gas to the combustor. The overheating of the gas-powered tool is prevented.

The primary advantage of the gas-powered tool according to the present invention is to control the temperature, thus preventing the crimping apparatus from damage and protecting the user from injury.

Other advantages and features of the invention will become apparent from the detailed description taken in conjunction with the drawings.

### BRIEF DESCRIPTION OF DRAWINGS

The present invention will be described through detailed illustration of four embodiments referring to the drawings.

FIG. 1 is a perspective view of a gas-powered gluing apparatus according to the first embodiment of the present invention.

FIG. 2 is an exploded view of a temperature-sensitive controller used in the gas-powered gluing apparatus shown in FIG. 1.

FIG. 3 is a cross-sectional view of the temperature-sensitive controller shown in FIG. 2.

FIG. 4 is a cross-sectional view of the gas-powered gluing apparatus shown in FIG. 1.

FIG. 5 is a cross-sectional view of the temperature-sensitive controller shown in FIG. 2 at the normal temperature.

FIG. 6 is a cross-sectional view of the gas-powered gluing apparatus shown in FIG. 1 at the normal temperature.

FIG. 7 is a cross-sectional view of the controller shown in FIG. 2 at a working temperature.

FIG. 8 is a cross-sectional view of the controller shown in FIG. 2 at an excessively high temperature.

FIG. 9 is a cross-sectional view of a gas-powered soldering apparatus according to the second embodiment of the present invention.

FIG. 10 is a cross-sectional view of a gas-powered blower according to the third embodiment of the present invention.

FIG. 11 is a cutaway view of a gas-powered gluing apparatus according to the fourth embodiment of the present invention.

FIG. 12 is a cross-sectional view of the gas-powered gluing apparatus shown in FIG. 11.

### DETAILED DESCRIPTION OF EMBODIMENTS

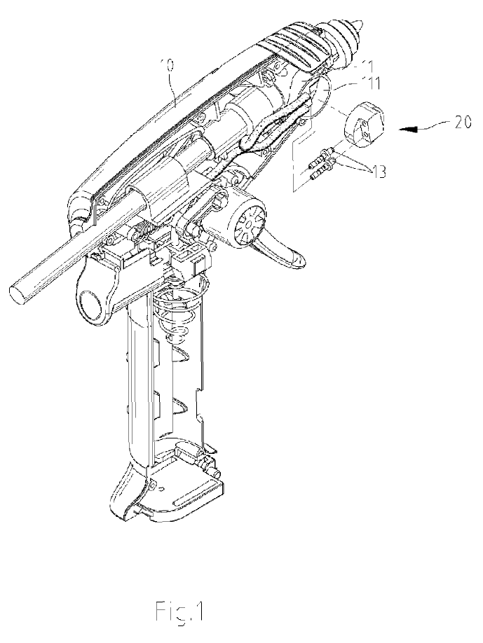

Referring to FIG. 1, there is shown a gas-powered gluing apparatus according to a first embodiment of the present invention. The gas-powered gluing apparatus includes a barrel 10, a combustor 11 installed in the barrel 10 to combust gas and a controller 20 installed in the barrel 10 to control the supply of the gas to the combustor 11. The combustor 11 includes an annular wall for receiving the controller 20.

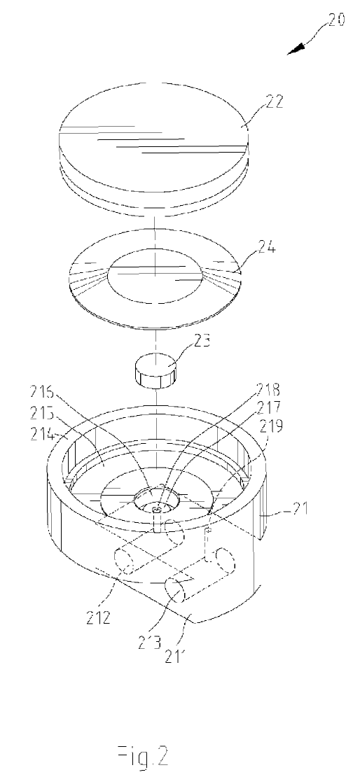

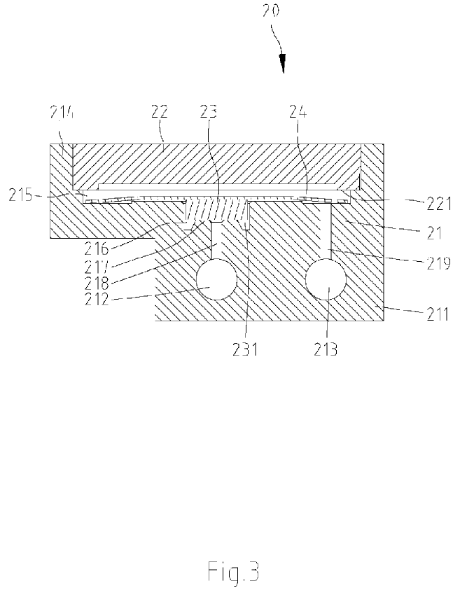

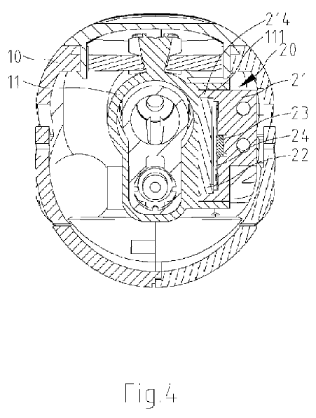

Referring to FIGS. 2 through 4, the controller 20 includes a shell 21, a valve 23, a temperature-sensitive regulator 24 and a cover 22.

The shell 21 is fit in the annular wall 111 of the combustor 11. The shell 21 includes a first portion 211 and a second portion 214. The first portion 211 of the shell 21 defines an intake 212 and an outlet 213. The intake 212 is connected to a reservoir through a pipe. The outlet 213 is connected to the combustor 11 through another pipe. The second portion 214 of the shell 21 defines a large space 215 and a small space 216 in communication with the larges space 215. There is a channel 218 for communicating the intake 212 with the small space 216. An annular ridge 217 is formed on the floor of the small space 216 around the channel 218. There is a channel 219 for communicating the outlet 213 with the large space 215.

The valve 23 is movably installed in the small space 216. The valve 23 includes a lower face 231 and an upper face. The lower face 231 of the valve 23 is used for air-tight contact with the annular ridge 217. As the lower surface 231 of the valve 23 is rested on the annular ridge 217, the upper face of the valve 23 is located outside the small space 216.

The temperature-sensitive regulator 24 is located in the large space 215 for contact with the valve 23. The temperature-sensitive regulator 24 is a laminate consisting of two metal layers with different thermal expansion coefficients.

The cover 22 is installed in the large space 215. The cover 22 includes a lower face, an upper face and an annular ridge 221 formed on the lower face. The annular ridge 221 is used for contact with the temperature-sensitive regulator 24.

The temperature-sensitive regulator 24 includes a convex-concave shape. That is, the center of the temperature-sensitive regulator 24 protrudes upwards while the edge of the same bends downwards. The edge of the temperature-sensitive regulator 24 is not in contact with the annular ridge 221.

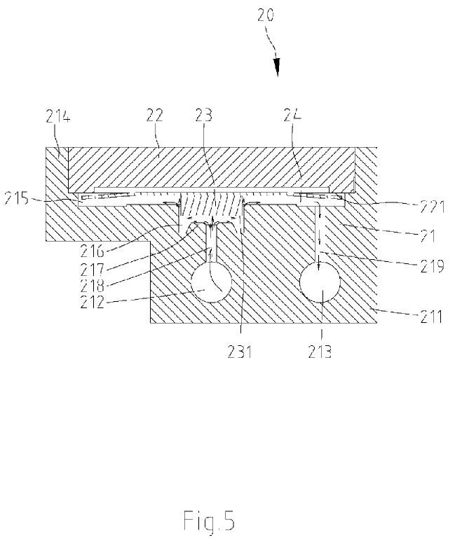

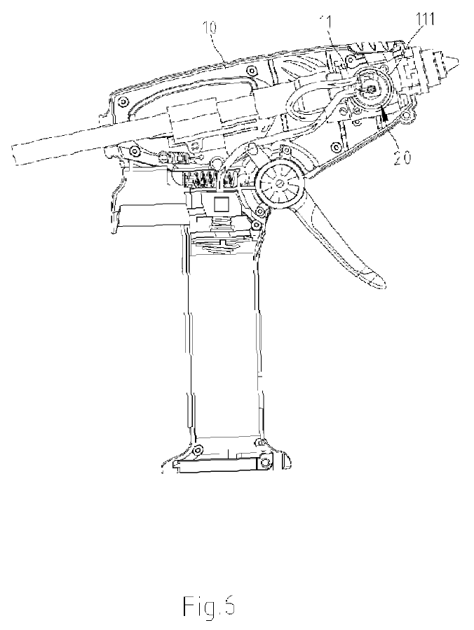

Referring to FIGS. 5 and 6, at the normal temperature, the gas goes into the small space 216 through the channel 218 and the intake 212. The gas lifts the valve 23 from the annular ridge 217. A gap between the valve 23 and the annular ridge 217 is large. In turn, the valve 23 lifts the temperature-sensitive regulator 24 from the floor of the large space 215. The gas goes all the way through the intake 212, the channel 218, the small space 216, the large space 215, the channel 219 and the outlet 213. The gas goes into the combustor 11 through the controller 20 at a high rate so that the combustion of the gas takes place at a high rate in the combustor 11. The temperature rises fast.

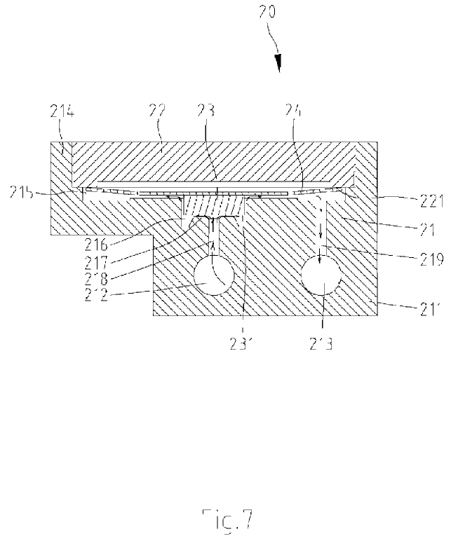

Referring to FIG. 7, as the temperature of the temperature-sensitive regulator 24 reaches a predetermined value (“working temperature”), the edge of the temperature-sensitive regulator 24 begins to bend upwards and contact the annular ridge 221 while the center of the same begins to protrude downwards and contact the valve 23 so that the gap between the valve 23 and the annular ridge 217 is reduced. The gas goes into the combustor 11 via the controller at a reduced rate. The combustion of the gas proceeds in the combustor 11 at a reduced rate.

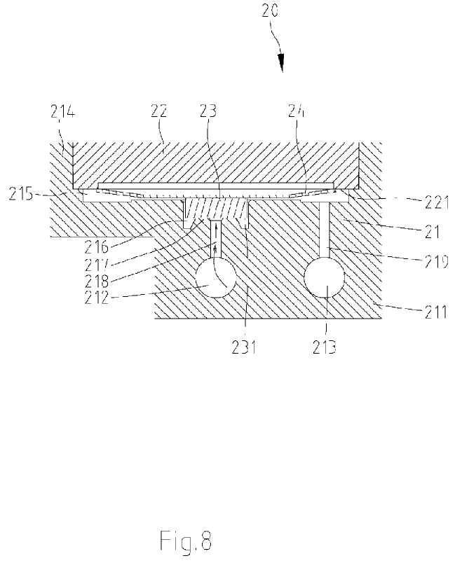

Referring to FIG. 8, as the temperature-sensitive regulator 24 gets too hot, the edge of the temperature-sensitive regulator 24 is in firm contact with the annular ridge 221 while the center of the same is in firm contact with the valve 23 so that the gap between the valve 23 and the annular ridge 217 is eliminated. The gas does not go into the combustor 11 through the controller at all. The combustion of the gas stops in the combustor 11. The rise of the temperature of the gluing apparatus stops. A user is protected from getting burnt.

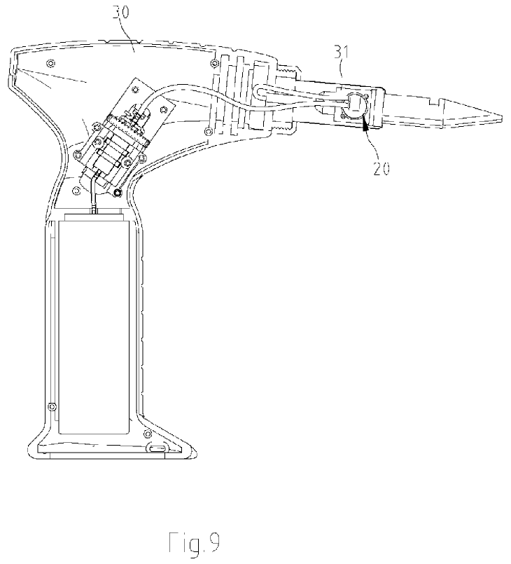

Referring to FIG. 9, there is shown a gas-powered soldering apparatus according to a second embodiment of the present invention. The gas-powered soldering apparatus includes a barrel 30, a combustor 31 installed in the barrel 30 to combust gas and the controller 20 that has been described in relation to the first embodiment.

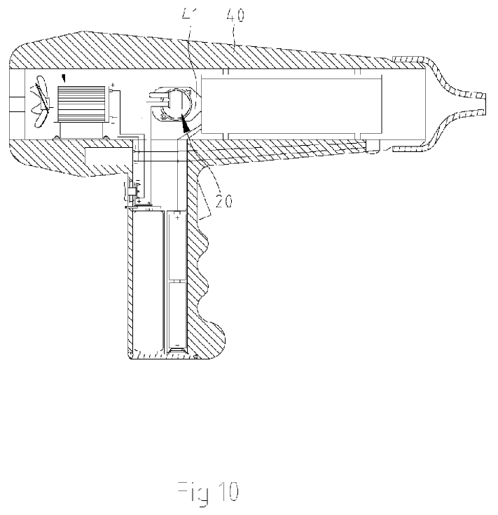

Referring to FIG. 10, there is shown a gas-powered blower according to a third embodiment of the present invention. The gas-powered blower includes a barrel 40, a combustor 41 installed in the barrel 40 to combust gas, the controller 20 that has been described in relation to the first embodiment and a fan installed in the barrel 40 to blow air through the combustor 41.

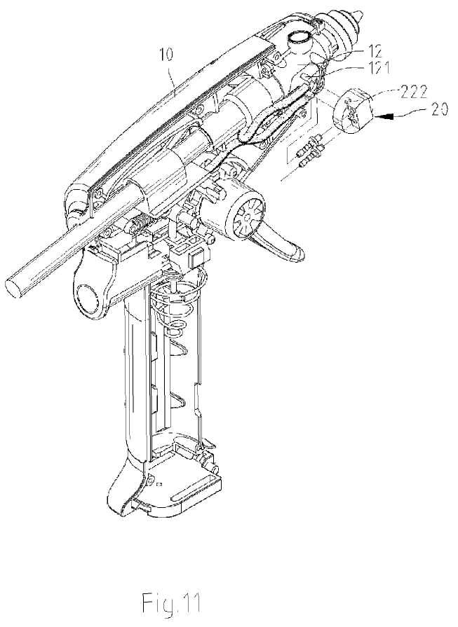

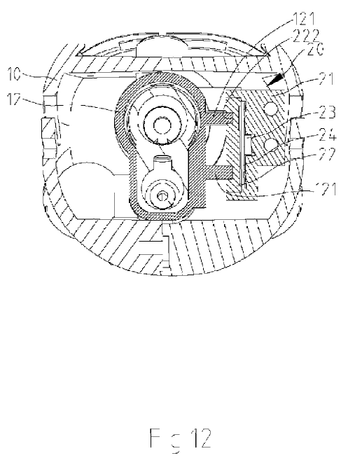

Referring to FIGS. 11 and 12, there is shown a gas-powered gluing apparatus according to a fourth embodiment of the present invention. The fourth embodiment is like the first embodiment except including a combustor 12 instead of the combustor 11. The combustor 12 is like the combustor 11 except including two rods 121 instead of the annular wall 111. The rods 121 are fit in two recesses 222 defined in the cover 22.

The primary advantage of the gas-powered tool according to the present invention is to avoid overheating, thus preventing the crimping apparatus from damage and protecting the user from injury.

The present invention has been described through the detailed illustration of the embodiments. Those skilled in the art can derive variations from the embodiments. Therefore, the embodiments shall not limit the scope of the present invention defined in the claims.

What is claimed is:

1. A gas-powered tool comprising a barrel, a combustor installed in the barrel to combust gas and a controller installed in the barrel to control the temperature by controlling the supply of the gas to the combustor.

2. The gas-powered tool according to claim 1 wherein the controller comprises:
a shell defining an intake, a first space in communication with the intake, a second space in communication with the first space and an outlet in communication with the second space;
a valve installed in the first space for shutting the intake;
a temperature-sensitive regulator installed in the second space for contact with the valve; and
a cover for shutting the second space and contacting the temperature-sensitive regulator.

3. The gas-powered tool according to claim 2 wherein the shell defines a channel for communicating the intake with the first space.

4. The gas-powered tool according to claim 3 wherein the shell comprises an annular ridge on the floor of the first space around the channel for contact with the valve.

5. The gas-powered tool according to claim 2 wherein the shell defines a channel for communicating the second space with the outlet.

6. The gas-powered tool according to claim 2 wherein the cover comprises an annular edge for contact with the temperature-sensitive regulator.

7. The gas-powered tool according to claim 1 wherein the combustor comprises an annular wall for receiving the controller.

8. The gas-powered tool according to claim 1 wherein the combustor comprises a plurality of rods formed thereon, and the controller comprises a corresponding number of recesses for receiving the rods.

9. The gas-powered tool according to claim 1 wherein the gas-powered tool is a gluing apparatus.

10. The gas-powered tool according to claim 1 wherein the gas-powered tool is a soldering apparatus.

11. The gas-powered tool according to claim 1 wherein the gas-powered tool is a blower.

12. The gas-powered tool according to claim 2 wherein the temperature-sensitive regulator is a laminate consisting of two metal layers with different coefficients of thermal expansion.
